(19) United States
(12) Patent Application Publication
(10) Pub. No.: US 2015/0203280 A1
(43) Pub. Date: Jul. 23, 2015

(54) Lovely Life Costume and Designer Jewelry for Emergency Alert Devices

(71) Applicant: Elizabeth Delaney Smith, Gainesville, FL (US)

(72) Inventor: Elizabeth Delaney Smith, Gainesville, FL (US)

(21) Appl. No.: 14/098,129

(22) Filed: Jan. 17, 2014

(51) Int. Cl. B65D 85/00; G08B 21/02; A44C 15/00

(52) U.S. Cl. CPC B65D 85/00; A44C 15/00; G08B 21/02

(57) ABSTRACT

This is a unique and original concept that utilizes existing and future emergency alert devices. This patent would include utility and design properties. The Lovely Life Jewelry could either house existing and future alert devices and/or be designed with circuitry that is compatible with existing and future emergency services.

This concept patent would include all types of current and future emergency devices to be made more attractive by enhancing the device appearance with all types of costume and designer jewelry and their attachments including chains, broach type attachment, wrist or arm bands.

This patent would include jewelry made with internal circuitry to connect with emergency alert services and/or costume or designer jewelry that accommodates emergency alert devices by sliding over, encasing, housing or otherwise attaching to emergency alert devices.

The purpose of Lovely Life Jewelry is to make emergency alert devices more attractive and therefore increasing usage, compliance and safety to targeted populations. All the Lovely Life Jewelry must be designed to enhance emergency response through compatibility with emergency devices and services.

Although the individual components of Lovely Life Jewelry may be available this is a novel and orginal idea that could benefit mankind. Therefore, I submit this patent application and request my concept be patented.

### CROSS REFERENCE TO RELATED APPLICATION

Design Patent Application No. 29/475,729

This is a unique and original concept that utilizes existing and future emergency alert devices. This patent would include utility and design properties. The Lovely Life Jewelry could either house existing and future alert devices and/or be designed with circuitry that is compatible with existing and future emergency services.

This concept patent would include all types of current and future emergency devices to be made more attractive by enhancing the device appearance with all types of costume and designer jewelry and their attachments including chains, broach type attachment, wrist or arm bands.

This patent would include jewelry made with internal circuitry to connect with emergency alert services and/or costume or designer jewelry that accommodates emergency alert devices by sliding over, encasing otherwise attaching to emergency alert devices.

The purpose of Lovely Life Costume or Design Jewelry is to make emergency alert devices more attractive and therefore increasing usage, compliance and safety to targeted populations. All the Lovely Life Jewelry must be designed to enhance emergency response through compatibility with emergency devices and services.

Although the individual components of Lovely Life Jewelry may be available this is a novel and orginal idea that could benefit mankind. Therefore, I submit this patent application and request my concept be patented.

### DESCRIPTION

A concept patent of all types of designs of costume and designer jewelry to accommodate emergency alert devices. The patent would include jewelry that could be made with internal circuitry to connect with existing and future emergency alert services and /or costume or designer jewelry that accommodates existing or future emergency alert devices by sliding over, encasing, housing or otherwise attaching to emergency alert devices. The purpose of the ornamental designer or costume jewelry is to make emergency alert devices more attractive and, therefore, increase usage, compliance and safety to targeted populations. All the Lovely Life Jewelry must be designed to enhance emergency response through compatibility with existing or future emergency alert devices and services.

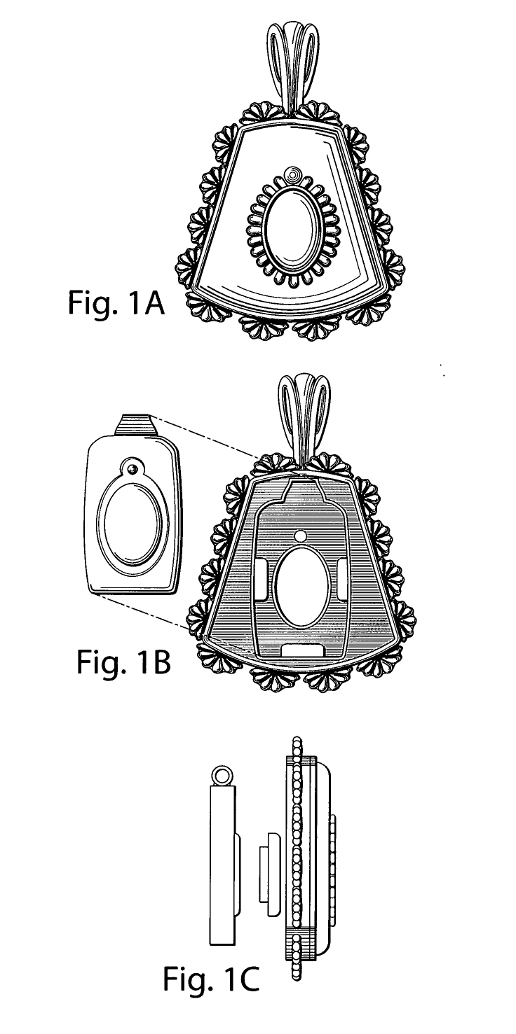

### Pendant Design Concept (See FIG. 1)

FIG. 1A: Front view example of my new pendant design concept. The actual appearance of the jewelry pieces vary.

FIG. 1B: Rear view example of my new pendant design concept which indicates how the emergency alert device could be inserted into the pendant.

FIG. 1C: Side view of of my new pendant design concept which shows the use and placement of a custom designed actuator button to activate the alert device. Right and left side views are mirror images.

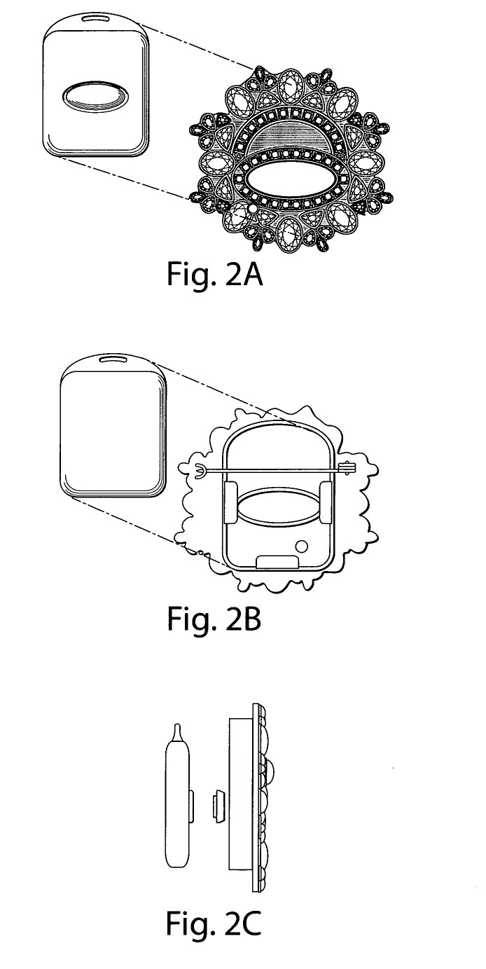

### Brooch Design Concept (See FIG. 2)

FIG. 2A: Front view example of my new brooch design concept. The actual appearance of the jewelry pieces vary.

FIG. 2B: Rear view example of my new brooch design concept which indicates how the emergency alert device could be inserted into the brooch.

FIG. 2C: Side view of of my new brooch design concept which shows the use and placement of a custom designed actuator button to activate the alert device. Right and left side views are mirror images.

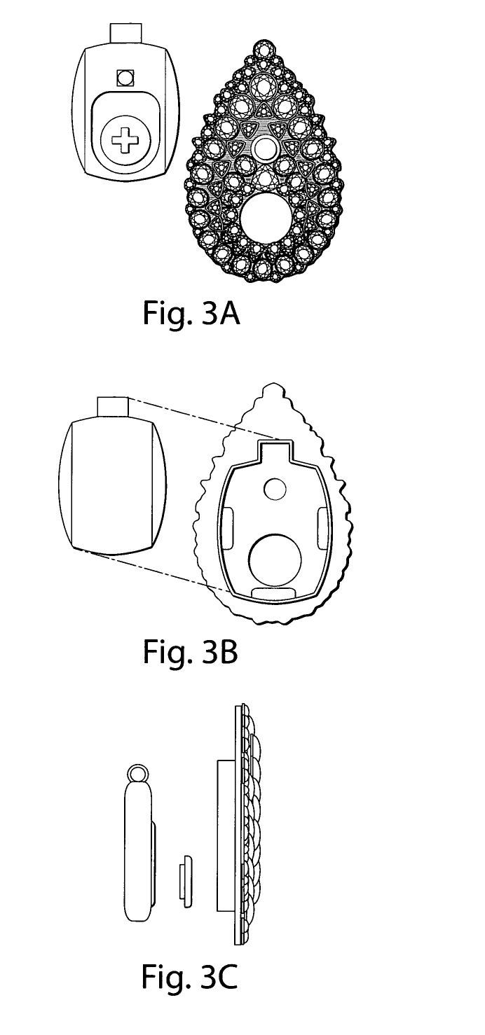

### Pendant/Brooch Design Concept (See FIG. 3)

FIG. 3A: Front view example of my new pendant/brooch design concept. The actual appearance of the jewelry pieces vary.

FIG. 3B: Rear view example of my new pendant/brooch design concept which indicates how the emergency alert device could be inserted into the pendant/brooch.

FIG. 3C: Side view of of my new pendant/brooch design concept which shows the use and placement of a custom designed actuator button to activate the alert device. Right and left side views are mirror images.

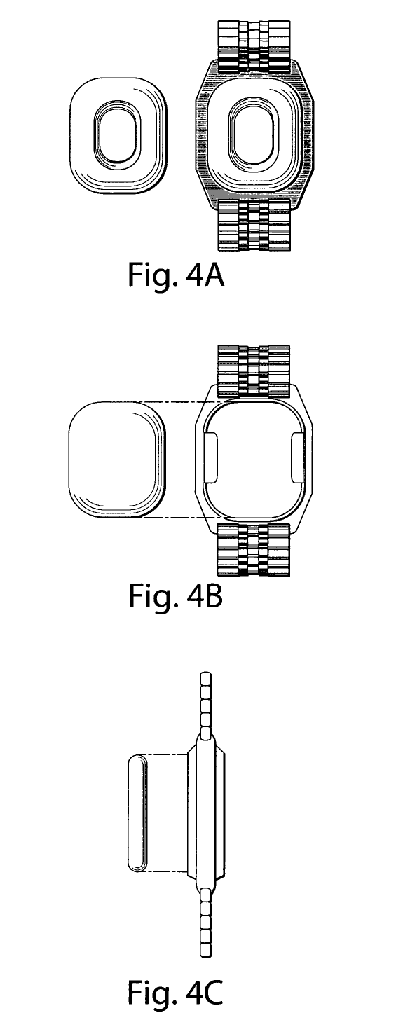

### Wristband Design Concept (See FIG. 4)

FIG. 4A: Front view example of my new wristband design concept. The actual appearance of the jewelry pieces vary.

FIG. 4B: Rear view example of my new wristband design concept which indicates how the emergency alert device could be inserted into the wristband.

FIG. 4C: Side view of of my new wristband design concept which shows the use and placement of a custom designed actuator button to activate the alert device. Right and left side views are mirror images.

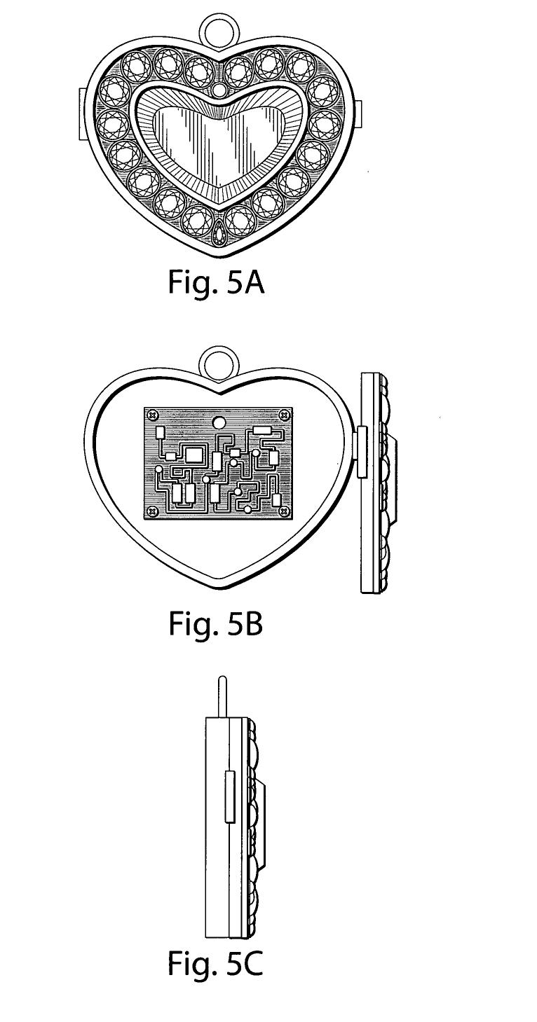

### Locket Design Concept (See FIG. 5)

FIG. 5A: Front view example of my locket design concept. The actual appearance of the jewelry pieces vary.

FIG. 5B: Open view example of my new locket design concept which indicates how the emergency alert device circuitry could be inserted into the locket.

FIG. 5C: Side view of of my new pendant design concept which shows the use and placement of a custom designed actuator button to activate the alert device. Right and left side views are mirror images.

1. I claim ornamental designs for Lovely Life Jewelry: Ornamental Enclosures for Emergency Alert Devices. This concept patent claim includes all types of costume and designer accommodating emergency alert devices. The patent includes jewelry that could be made with internal circuitry to connect with existing and future emergency alert services and/or costume or designer jewelry that accommodates existing and future emergency alert devices by sliding over, encasing, housing or otherwise attaching to emergency alert devices. The purpose of the designer or costume jewelry is to make emergency alert devices more attractive and, therefore, increase usage, compliance and safety for targeted populations. All Lovely Life Jewelry will enhance emergency response through compatibility with existing or future emergency alert devices and services.
I have invented a new concept for Lovely Life Jewelry: Costume and Designer Jewelry for Emergency Alert Devices: Lovely Life Jewelry: Ornamental Enclosures for Emergency Alert Devices as set forth in the application example drawings and application descriptions in the Preamble, Patent Concept and all other application descriptions.
